(19) United States
(12) Patent Application Publication
(10) Pub. No.: US 2026/0229038 A1
(43) Pub. Date: Aug. 6, 2026

(54) SYSTEM AND METHOD FOR IDENTIFYING A TRAFFIC ANOMALY

(71) Applicant: The Chinese University of Hong Kong, New Territories (CN)

(72) Inventors: Pheng-Ann Heng, New Territories (CN); Zhenghao Xing, New Territories (CN); Xiaowei Hu, Hung Hom (CN); Hao Chen, Lam Tin (CN); Chi-Wing FU, Tsuen Wan (CN)

(21) Appl. No.: 19/046,727

(22) Filed: Feb. 6, 2025

(51) Int. Cl. G06V 20/54; G06F 40/40; G06V 20/40; G10L 19/02

(52) U.S. Cl. CPC G06V 20/54; G06F 40/40; G06V 20/41; G06V 20/44; G06V 20/46; G10L 19/0204

(57) ABSTRACT

A computer-implemented method for identifying a traffic anomaly includes: receiving a video stream of traffic, wherein the video stream includes two input categories wherein the two input categories are audio data and visual data, simultaneously processing audio data and visual data to identify a traffic anomaly, generating an output of the identified traffic anomaly, and; presenting the generated output of the identified traffic anomaly to a user.

### TECHNICAL FIELD

The present invention relates to a system and method for identifying a traffic anomaly utilising two or more input categories.

### BACKGROUND

Traffic anomaly identification is receiving increasing attention, given the practical need of detecting, analysing and responding to traffic anomalies such as accidents and other traffic anomalies (i.e., traffic incidents). Access to identified traffic anomalies (i.e., traffic incidents) can be important for reducing damage, alerting emergency services, lifesaving, enhancing public safety, and improved transportation efficiency.

Current traffic anomaly identification methods focus largely detect unexpected events and analyse their causes in traffic scenarios using recorded videos. Current traffic anomaly identification methods focus on detecting anomalies in traffic scenarios using visual data from video or images. The current methods focus mainly on detection, often neglecting the description and causal analysis of anomalies.

In many real-world situations, traffic anomalies usually involve audio cues such as honking, braking, skidding, crashes and other sounds which occur largely beyond the camera's field of view. It is difficult to fully capture and interpret the anomaly events when using only visual information.

### SUMMARY OF THE INVENTION

The present invention relates to a method and system for identifying a traffic anomaly (or anomalies) that provides improved traffic anomaly identification by processing inputs from two different categories, or at least provides the public with a useful alternative.

The present invention relates to a multi modal method for identifying a traffic anomaly (or anomalies) that simultaneously uses at least two input categories i.e., two input modalities to provide accurate traffic anomaly identification. The present invention also relates to a multi modal system for identifying a traffic anomaly that uses at least two input categories and processes the inputs to provide accurate traffic anomaly identification. The system may be adapted to execute the method for identifying a traffic anomaly. The system and method identify traffic anomalies more accurately than systems that just rely on visual data, due to the combined used of audio and visual data.

According to a first aspect, there is provided a computer-implemented method for identifying a traffic anomaly, comprising:
receiving a video stream of traffic, wherein the video stream comprises two input categories
wherein the two input categories are audio data and visual data,
simultaneously processing audio data and visual data to identify a traffic anomaly,
generating an output of the identified traffic anomaly, and;
presenting the generated output of the identified traffic anomaly to a user.

The method is advantageous because it integrates audio data in combination with visual data (i.e., the graphic data) to provide a more comprehensive and accurate analysis of traffic anomalies i.e., traffic incidents.

In one example the output is a textual description of the identified traffic anomaly or traffic anomalies.

In one example the method comprising the step of identifying one or more anomalous events in the video stream by applying spectral flux computation.

In one example the spectral flux computation comprises:
measuring a change in audio data power spectrum by comparing consecutive frames in the video stream,
determining sudden variations in the audio data,
wherein the sudden variations in the audio data are indicative of a traffic anomaly,
selecting frames within which the sudden variations in the audio data are determined.

In one example the step of selecting frames comprises detecting a highest spectral value or largest amplitude at each predefined time segment of the video stream and selecting frames where the highest spectral value or largest amplitude is detected.

In one example, the method comprising:
feeding the audio data into an audio encoder,
transforming audio data into spectrograms,
generating encoded audio data, wherein the encoded audio data comprises a plurality of audio tokens.

In one example, the method comprising:
feeding the selected frames into a visual encoder,
processing the selected frames to extract visual features,
generating encoded visual data, wherein the encoded visual data comprises a plurality of visual tokens.

In one example, the method comprising merging the encoded visual data and encoded audio data into a fused audio-visual data (AV data) by applying self-attention mechanisms to balance contributions of audio data and visual data in the fused AV data.

In one example the step of merging the encoded visual data and encoded audio data into the fused AV data comprising the additional steps of:
producing a fixed length audio token set by processing the audio tokens by an audio Q former,
producing a fixed length visual token set by processing the visual tokens by a video Q former,
projecting the into a large language model embedding space,
wherein the audio tokens and visual tokens are concatenated into the fused AV data.

In one example, the method comprising the steps of:
decoding the fused AV data,
generating natural language outputs from the decoded fused AV data.

In one example the natural language outputs are textual outputs, and the method comprises presenting the textual outputs on a display.

In one example the natural language outputs comprise at least one or more of: identified anomaly type, causal inference, prevention strategies and response recommendations.

The textual data that is generated and presented provides detailed information for users to understand the cause of a traffic incident and prevention strategies to avoid similar incidents in the future. Textual outputs provide a simple to understand format and allows appropriate users e.g., fire department or traffic police to quickly decipher the detected traffic anomaly.

In one example the decoding and generating natural language outputs are generated by a LLaMA2 large language model that is trained to process the fused AV data and generate the natural language outputs.

According to a further aspect there is provided a multi modal model for identifying a traffic anomaly, in particular for use in the method of any one of the earlier method statements, the multi modal model comprising:
an audio insight frame selector configured to identify one or more anomalous events in an input video stream of traffic by applying spectral flux computation, and select each frame in the video stream that includes the identified one or more anomalous events,
an audio encoder and a visual encoder operatively coupled to the audio insight frame selector, the audio encoder and visual encoders adapted to receive the selected video frames,
wherein the visual encoder is configured to:
   process the frames by applying a ViT-g/14 model to encode visual data,
wherein the audio encoder is configured to:
   segment an audio time series extracted from the video frames into predefined segments, wherein each segment being a predefined time interval,
   transform the extracted audio time series at each segment into spectrograms,
   generate encoded audio data,
an audio-visual dynamic connector configured to fuse the encoded visual data and the encoded audio data into a fused audio-visual data (fused AV data) by applying a self-attention mechanism,
wherein the audio-visual dynamic connector comprising:
   a visual Q former,
   an audio Q former,
   a self-attention mechanism,
   the visual Q former and the audio Q former are configured to process the encoded visual data and encoded audio data respectively to produce one or more fixed length token sets,
   the audio-visual dynamic connector configured to concatenate the fixed length token sets and generate a concatenated AV data set,
   the self-attention mechanism generates weights and apply the generated weights to the concatenated AV data set by dot product to generate an LLM input AV data set,
a decoder configured to:
   receive LLM input AV data set,
   convert the input AV data set into language features, and;
   concatenating the language features to form one or more prompts,
a large language model (LLM) is configured to process the concatenated language features and generate one or more natural language outputs, wherein the LLM is a LLaMA2 model, wherein the natural language outputs are a textual output and;
wherein the textual outputs comprise at least one or more of: anomaly type, causal inference, prevention strategies and response recommendations.

The multi modal model as described above may be executed by computing apparatus. In one optional example multi modal model as described above may be a multi modal model. The multi modal model may be a machine learning model.

According to a further aspect, there is provided a system for identifying a traffic anomaly comprising:
a computing apparatus comprising a processor and a memory unit, the processor and memory unit being operatively coupled to each other,
the memory unit adapted to store instructions which, when executed by the processor cause the computing apparatus to perform the method as per any one or more of the method statements above.

According to a further aspect there is provided a data processing apparatus comprising means for carrying out the method of any one of the statements earlier.

According to a further aspect, there is provided a system for identifying a traffic anomaly comprising:
a computing apparatus comprising a processor and a memory unit, the processor and memory unit being operatively coupled to each other,
the computing apparatus further comprising a display operatively coupled to the processor, the display adapted to present one or more outputs,
the computing apparatus further comprising:
   an audio insight frame selector configured to identify one or more anomalous events in an input video stream of traffic by applying spectral flux computation, and select each frame in the video stream that includes the identified one or more anomalous events,
   an audio encoder and a visual encoder, the encoders configured to generate encoded audio data and encoded visual data,
   an audio-visual dynamic connector configured to fuse the encoded visual data and the encoded audio data into a fused audio-visual data (fused AV data),
   a large language model (LLM) that is trained to process the fused AV data and generate one or more natural language outputs,
wherein the natural language outputs are presented on the display.

In one example the natural language outputs are a textual output and; wherein the textual outputs comprise at least one or more of: anomaly type, causal inference, prevention strategies and response recommendations, and display configured to present the textual outputs to a user.

The system as described is advantageous because it integrates audio data in combination with visual data to provide a more comprehensive and accurate analysis of traffic anomalies i.e., traffic incidents. By incorporating audio cues such as honking, collisions, and braking sounds, it provides a more comprehensive understanding, even for events outside the camera's field of view or in poor visibility conditions.

In one example the visual encoder is configured to: process the frames by applying a ViT-g/14 model to generate encoded visual data,
wherein the audio encoder is configured to: segment an audio time series extracted from the video frames into predefined segments, wherein each segment being a predefined time interval, transform the extracted audio time series at each segment into spectrograms, and generate encoded audio data.

In one example the audio-visual dynamic connector comprising:
a visual Q former,
an audio Q former,
a self-attention mechanism,
wherein the visual Q former and the audio Q former are configured to process the encoded visual data and encoded audio data respectively to produce one or more fixed length token sets,
wherein the audio-visual dynamic connector configured to concatenate the fixed length token sets and generate a concatenated AV data set,
wherein the self-attention mechanism generates weights and apply the generated weights to the concatenated AV data set by dot product to generate an LLM input AV data set,
the computing apparatus further comprising
a decoder configured to:
   receive LLM input AV data set,
   convert the input AV data set into language features, and;
   concatenate the language features to form one or more prompts,
wherein the large language model (LLM) is configured to process the concatenated language features and generate the one or more natural language outputs, and wherein the LLM is a LLaMA2 model.

In one example the system comprises one or more cameras adapted to capture a video stream of traffic. The cameras may be fixed cameras positioned on traffic signal posts or lamp posts or other structures and may be oriented to capture video of traffic flows. The cameras may be mounted at specific locations e.g., high traffic density areas. The cameras may be arranged to communicate with the computing apparatus and transmit captured video stream to the computing apparatus via a wireless network.

According to a further aspect there is provided a computer-implemented method for generating a training dataset for a machine-learning model, in particular the machine-learning model of described herein, comprising:
collecting a plurality of traffic videos from a plurality of sources, wherein each video depicts at least one traffic anomaly,
trimming the videos to capture causes and consequences of the anomalies,
labelling the trimmed videos,
wherein the timed videos further include labels, the labels being textual outputs indicating information indicative of: anomaly type, causal inference, prevention strategies and response recommendations, wherein the textual outputs define Q&A pairs.

A training dataset for use in the method of training a machine-learning model as described herein, comprising: at least 29,000 anomalous traffic videos and at least 149,000 targeted Q&A pairs.

The dataset generated provides a significant labelled dataset that can be used for future traffic anomaly detection development and for enhancing the multi modal model described herein.

According to a further aspect there is provided a computer program comprising instructions which, when the program is executed by a computer, cause the computer to carry out the method of any one of the method statements above.

According to a further aspect there is provided a computer-readable medium comprising instructions which, when executed by a computer, cause the computer to carry out the method of any one of the method statements above.

In one example the method as described can be used for at least one of:
traffic management by government or municipal agencies to enhance traffic flow, reduce congestion, and improve road safety,
autonomous vehicle control to improve situational awareness and enhance vehicle safety systems,
emergency services to enable faster and more efficient responses to traffic incidents due to the improved accuracy and responses can be planned based on the textual outputs,
surveillance system providers in traffic surveillance systems,
insurance companies to assess the party at fault in accidents.

The method and system as described herein has many applications for traffic management, incident detection and other uses.

The term “comprising” (and its grammatical variations) as used herein are used in the inclusive sense of “having” or “including” and not in the sense of “consisting only of”.

The term “traffic anomaly” (and its grammatical variations) as used herein are used to define traffic incidents such as for example an accident, breakdown, traffic crimes, honking, traffic build up, illegal driving, and/or any other unusual incident that occurs in traffic or on the road. The terms “traffic incident” may be used as an alternative to the term “traffic anomaly”.

The term “visual data” (and its grammatical variations) as used herein are used to define the visual or pictorial or graphic components of the video stream and not the audio components.

It is to be understood that, if any prior art information is referred to herein, such reference does not constitute an admission that the information forms a part of the common general knowledge in the art.

### BRIEF DESCRIPTION OF THE DRAWINGS

Embodiments of the present invention will now be described, by way of example, with reference to the accompanying drawings in which:

FIG. 1 is a schematic diagram of one embodiment of a system for detecting a traffic anomaly.

FIG. 2 illustrates a schematic diagram of the hardware components of a computing apparatus that forms part or forms the system for detecting a traffic anomaly.

FIG. 3 illustrates an flow diagram of a computer implemented method for detecting a traffic anomaly.

FIG. 4 illustrates an architecture diagram of a multi modal model for detecting a traffic anomaly.

FIG. 5 illustrates an example of spectral flux computation performed by the audio insight frame selector of the model in FIG. 3.

FIG. 6 illustrates a flow chart for a computer implemented method for generating a training dataset.

FIG. 7 illustrates a categorisation tool 702 of the various reasons for traffic anomalies.

FIG. 8 illustrates a table of the model of FIG. 3 (EchoTraffic's) performance compared with other traffic anomaly detection models across all evaluation metrics.

FIG. 9 illustrates a test of the model performance of the model of FIG. 3 (i.e., EchoTraffic) on a challenging scenario where limited visual cues make detecting a collision difficult.

### DETAILED DESCRIPTION OF THE PREFERRED EMBODIMENTS

The present invention relates to a system and method for traffic anomaly identification. The system may be a multi model system that is configured to utilise two or more input categories to identify a traffic anomaly.

In one example, the system for detecting a traffic anomaly is a multimodal audio-visual system for traffic anomaly detection. The system both audio data and visual data for enhanced traffic anomaly

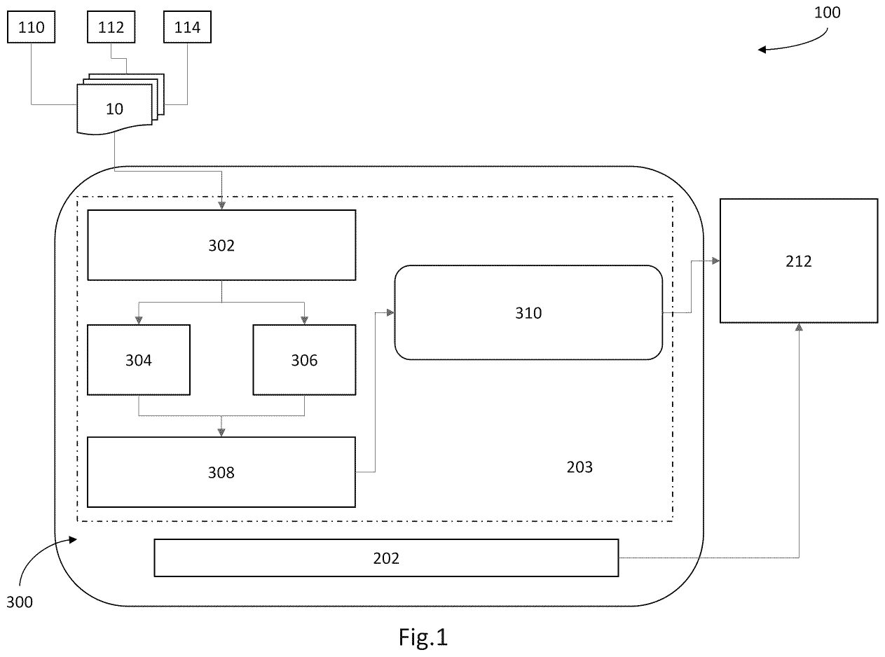

Referring to FIG. 1, an embodiment of the present invention is illustrated. This embodiment is arranged to provide a system 100 for identifying a traffic anomaly comprising: a computing apparatus 200 comprising a processor 202. The computing apparatus 200 further comprising a display 212 and the display 212 is adapted to present one or more outputs. The computing apparatus 200 further comprising: an audio insight frame selector 302, an audio encoder 304, a visual encoder 306, an audio-visual dynamic connector 308 and an AI model e.g., a large language model (LLM) 310. The audio insight frame connector 302 is configured to identify one or more anomalous events in an input video stream 10 of traffic by applying spectral flux computation and selecting each frame in the video stream that includes the identified one or more anomalous events. The encoders 304, 306 are configured to generate encoded audio data and encoded visual data. The audio-visual dynamic connector 308 is configured to fuse the encoded visual data and the encoded audio data into a fused audio-visual data (fused AV data). The large language model (LLM) 310 is trained to process the fused AV data and generate one or more natural language outputs. The natural language outputs are presented on the display 212.

The natural language outputs are a textual outputs i.e. text-based outputs such as phrases or sentences. The textual outputs may be outputted by the LLM 310. In one example the textual outputs comprise at least one or more of: anomaly type, causal inference, prevention strategies and response recommendations. In one example and wherein the LLM 310 is a LLaMA2 model. The textual outputs with information related to the identified anomaly are presented on the display 212.

The system 100 may optionally comprise one or more cameras. As shown in FIG. 1, the system 100 may comprise a plurality of cameras 110, 112, 114. The cameras 110-114 may be wirelessly coupled to the computing apparatus 200. The cameras 110-114 may transmit recorded video stream via a wireless network e.g., a cellular network. Optionally, one or more of the cameras 110-114 may be coupled to the computing apparatus 200 by a wired connection.

The cameras 110-114 may be mounted in any suitable locations such as for example on traffic lights, lamp posts or in other locations. In another example, one or more cameras may be a dash cam mounted in a vehicle. Each camera 110-114 is adapted to record a video stream that includes audio data and visual data. The video stream 10 from each camera 110-114 may be transmitted to the computing apparatus 200. The video stream 10 is received and processed by the computing apparatus 200 to identify a traffic anomaly by processing the audio and visual data and generating textual data.

The system 100 for identifying a traffic anomaly may be used to identify multiple traffic anomalies. The system 100 may identify one or traffic anomalies i.e., traffic incidents in real time from a video stream received from at least one camera. The system 100 as described is advantageous because it integrates audio data in combination with visual data to provide a more comprehensive and accurate analysis of traffic anomalies i.e., traffic incidents. By incorporating audio cues such as honking, collisions, and braking sounds, it provides a more comprehensive understanding, even for events outside the camera's field of view or in poor visibility conditions. Additionally using both audio and visual data the system 100 can provide a more comprehensive description of the identified traffic incident.

The visual encoder 306 (i.e., a video encoder) is configured to process the video frames by applying a ViT-g/14 model to generate encoded visual data. The audio encoder 304 is configured to segment an audio time series extracted from the video frames into predefined segments, wherein each segment being a predefined time interval, transform the extracted audio time series at each segment into spectrograms, and generate encoded audio data.

The audio-visual dynamic connector 308 is configured to process the encoded visual data and encoded audio data respectively to produce one or more fixed length token sets. The audio-visual dynamic connector is configured to concatenate the fixed length token sets and generate a concatenated AV data set. The dynamic connector 308 is configured to apply one or more generated weights to the concatenated AV data set by dot product to generate an LLM input AV data set.

The computing apparatus 200 comprises a decoder 312. The decoder 312 is configured to receive LLM input AV data set, convert the input AV data set into language features, and; concatenate the language features to form one or more prompts. The LLM 310 is trained to process the concatenated language features and generate the one or more natural language outputs. The display 212 is adapted to present the natural language outputs to a user e.g., emergency staff or municipal staff or other authorized users.

In this example embodiment, the computing apparatus 200 may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing apparatus 200 may be appropriately programmed to implement the invention.

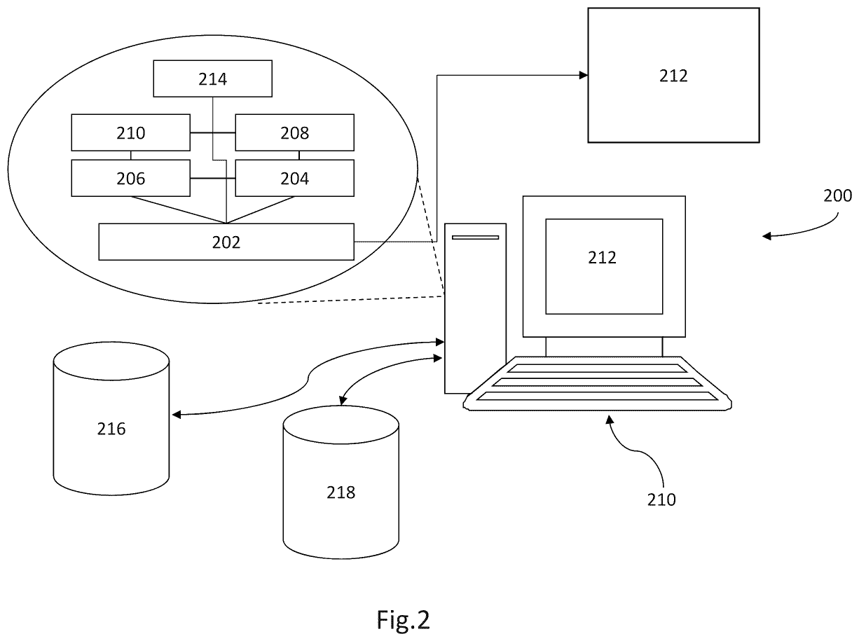

As shown in FIG. 2 there is a shown a schematic diagram of the computing apparatus 200. The computing apparatus 200 may optionally be arranged to be implemented as an example embodiment of a system for identifying a traffic anomaly. FIG. 2 may illustrate an example of the hardware components of the computing apparatus 200.

Referring to FIG. 2, the computing apparatus 200 includes suitable components necessary to receive, store and execute appropriate computer instructions. The components may include a processing unit 202, including Central Processing Unit (CPU), Math Co-Processing Unit (Math Processor), Graphic Processing Unit (GPUs) or Tensor processing unit (TPUs) for tensor or multi-dimensional array calculations or manipulation operations, a memory unit e.g., a read-only memory (ROM) 204, random access memory (RAM) 206, and input/output devices such as disk drives 208. The computing apparatus 200 comprises one or more input devices 210 such as an Ethernet port, a USB port, etc.

The computing apparatus comprises a display 212 such as a liquid crystal display, a light emitting display or any other suitable display. The display 212 may be integrated into the computing apparatus 200 or may be a remote display 212. The display 212 may be arranged to receive the generated natural language outputs and present them. In one example, the display 212 may be part of another device e.g., a tablet or a smartphone or other display 212.

The computing apparatus 200 may include instructions that may be included in ROM 204, RAM 206 or disk drives 208 and may be executed by the processing unit 202. There may be provided a plurality of communication links 214 which may variously connect to one or more computing devices such as a server, personal computers, terminals, wireless or handheld computing devices, Internet of Things (IoT) devices, smart devices, edge computing devices and/or to a remote display. At least one of a plurality of communications link may be connected to an external computing network through a telephone line or other type of communications link. In one example, the computing apparatus 200 and the display 212 may be arranged in a server client architecture.

The computing apparatus 200 may include storage devices such as a disk drive 208 which may encompass solid state drives, hard disk drives, optical drives, magnetic tape drives or remote or cloud-based storage devices. The computing apparatus 200 may use a single disk drive or multiple disk drives, or a remote storage service. The apparatus 200 may also have a suitable operating system which resides on the disk drive or in the ROM of the computing apparatus 200.

The computing apparatus may further comprise one or more databases adapted to store one or more pieces of data. For example, the computing apparatus may comprise a video stream database 216 that may be adapted to store the received video frames. The computing apparatus 200 may further comprise a training data database 218 that is configured to store a training dataset. In one example, the training dataset may comprise at least 29,000 anomalous traffic videos and at least 149,000 targeted Q&A pairs.

The computing apparatus 200 may also provide the necessary computational capabilities to operate or to interface with a machine learning network, such as a neural networks, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time. The computing apparatus may comprise one or more GPUs being operatively coupled to the CPU (i.e., processor). The computing apparatus 200 may comprise additional hardware elements operatively coupled to the CPU and/or the GPU to provide the computing apparatus components needed to implement a machine learning network or machine learning model. The learning network or model may be stored in a memory unit e.g., ROM 206. The computing apparatus 200 may comprise computational components and capabilities to execute one or more other models, e.g., software models.

In one example, the apparatus 200 may be configured to stored and execute a LLaMA2 model that is trained to generate natural language outputs based on processing concatenated AV data. In one example, the components 302-312 of the computing apparatus 200 may be software modules or engines (i.e., software components). The software modules or components 302-312 may be arranged as multi modal model that may be executable by the computing apparatus 200 and its hardware components. The multi modal model 300 may be in the form of software modules or software components executable by the computing apparatus 200. In one example the model 300 may be a machine learning model 300 (i.e., AI model). The software components may exchange data between other components.

The components 302-312 may be software modules that may be stored in a memory unit 203. The modules may include computer executable instructions that may be executed by the processor 202 to cause the computing apparatus to perform the functions of method 400 described below.

In an alternative form, each of the components 302-312 may be hardware modules or hardware logic blocks that may be operatively coupled together. The blocks may be controlled by the processor 202. The hardware modules or logic blocks may each perform functions as described herein.

In one example the computing apparatus 200 may be configured to execute method of identifying a traffic anomaly (or anomalies). In one example the computer-implemented method for identifying a traffic anomaly, comprises the steps of: receiving a video stream of traffic, wherein the video stream comprises two input categories, wherein the two input categories are audio data and visual data, simultaneously processing audio data and visual data to identify a traffic anomaly, generating an output of the identified traffic anomaly, and; presenting the generated output of the identified traffic anomaly to a user. The output may be a natural language output e.g., a textual output.

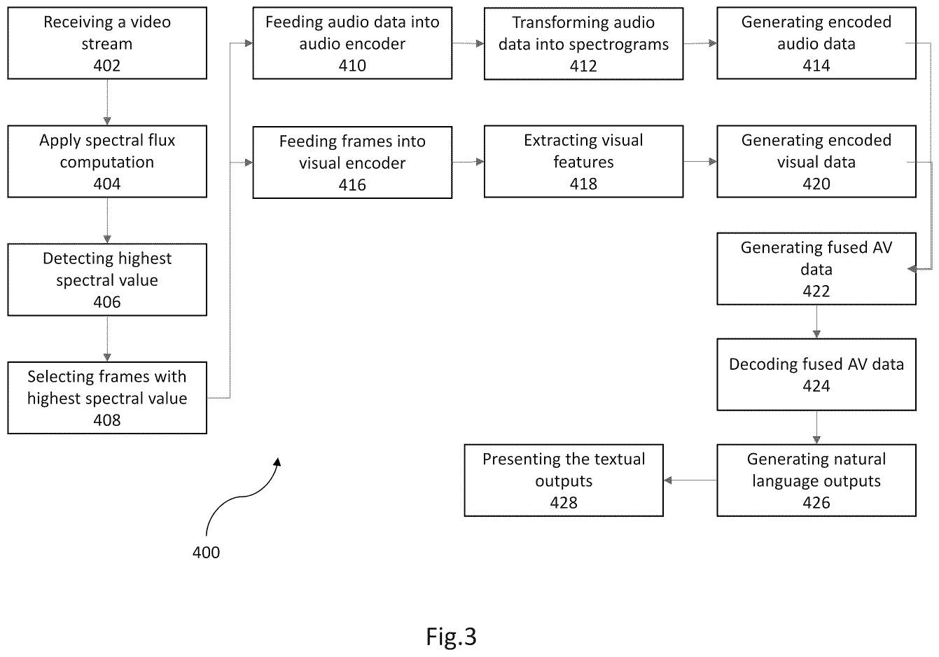

FIG. 3 illustrates an example embodiment of a computer implemented method 400 for identifying a traffic anomaly (or traffic anomalies). The method 400 commences at step 402. Step 402 comprises receiving a video stream of traffic, wherein the video stream comprises two input categories. The video stream may be received from the one or more cameras 110-114. The two input categories are audio data and visual data. Step 404 comprises identifying one or more anomalous events in the video stream by applying spectral flux computation.

In one example the spectral flux computation comprises: measuring a change in audio data power spectrum by comparing consecutive frames in the video stream and determining sudden variations in the audio data. The sudden variations in the audio data are indicative of a traffic anomaly.

Step 406 comprises detecting a highest spectral value or largest amplitude at each predefined time segment of the video stream. Step 408 comprises selecting frames where the highest spectral value or largest amplitude is detected.

Step 410 comprises feeding the audio data into an audio encoder. Step 412 comprises transforming audio data into spectrograms. Step 414 comprises generating encoded audio data, wherein the encoded audio data comprises a plurality of audio tokens. Step 416 comprises feeding the selected frames into a visual encoder. Step 418 comprises processing the selected frames to extract visual features. Step 420 comprises generating encoded visual data, wherein the encoded visual data comprises a plurality of visual tokens.

Step 422 comprises merging the encoded visual data and encoded audio data into a fused audio-visual data (AV data) by applying self-attention mechanisms to balance contributions of audio data and visual data in the fused AV data.

In one example the step of merging the encoded visual data and encoded audio data into the fused AV data comprising the additional steps of: producing a fixed length audio token set by processing the audio tokens by an audio Q former, producing a fixed length visual token set by processing the visual tokens by a video Q former, and projecting the into a large language model embedding space. The audio tokens and visual tokens are concatenated into the fused AV data.

Step 424 comprises decoding the fused AV data. Step 426 comprises generating natural language outputs from the decoded fused AV data. The natural language outputs are textual outputs, and the method comprises presenting the textual outputs on a display 212. In one example the natural language outputs comprise at least one or more of: identified anomaly type, causal inference, prevention strategies and response recommendations. In one example the output is a textual description of the identified traffic anomaly or traffic anomalies. Step 428 comprises presenting the textual data. Step 428 may be optional.

The textual data that is generated and presented provides detailed information for users to understand the cause of a traffic incident and prevention strategies to avoid similar incidents in the future. Textual outputs provide a simple to understand format and allows appropriate users e.g., fire department or traffic police to quickly decipher the detected traffic anomaly. In one example the decoding and generating natural language outputs are generated by a LLaMA2 large language model that is trained to process the fused AV data and generate the natural language outputs.

The method 400 is advantageous because it integrates audio data in combination with visual data (i.e., the graphic data) to provide a more comprehensive and accurate analysis of traffic anomalies i.e., traffic incidents.

The method 400 as described enhances traffic anomaly understanding by integrating audio and visual data, overcoming the limitations of visual-only methods. By incorporating audio cues such as honking, collisions, and braking sounds, it provides a more comprehensive understanding, even for events outside the camera's field of view or in poor visibility conditions.

The computing apparatus 200 as described may be programmed to perform the method 400. The method 400 may be in the form of a computer program or as a set of computer programs or a set of software modules that are configured to be executed by the processor 202. In one example, the method 400 may be embodied as a set of computer readable and executable instructions that when executed by the processor 202 cause the computing apparatus to perform the method 400 described herein.

In one example, the computing apparatus 200 may comprise a computer program comprising instructions which, when the program is executed by a computing apparatus 200 (i.e., computer), causes the computing apparatus 200 (i.e., computer) to carry out the method 400. In one example, the computing apparatus 200 may comprise a computer-readable medium comprising instructions which, when executed by a computing apparatus (i.e., computer), cause the computer to carry out the method 400. The computer readable medium may be a non-transitory computer readable medium.

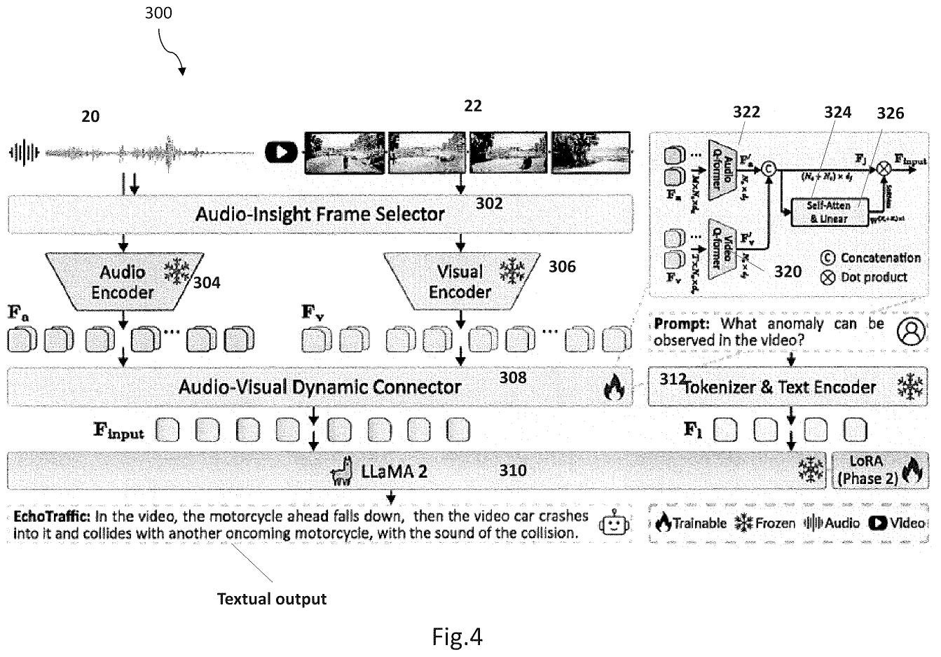

FIG. 4 illustrates an overview of a multi modal model 300 for identifying a traffic anomaly. The multi modal model 300 (i.e., AI model) may be used in the method 400. The multi modal model 300 and its components may be programmed to perform the steps of method 400. The model 300 components may form part of the system 100. Often, these key moments stand out not only visually but also audibly, with distinct audio signals. Referring to FIG. 4, the system 100 and/or model comprises

Existing video understanding models typically use uniform frame sampling, overlooking the fact that anomalous scenarios happen only in certain camera frames of a video stream that are critical. The multi modal model 300 integrates audio cues and visual data to enhance anomaly comprehension.

Referring to FIG. 4, the model 300 comprises an audio insight frame selector 302. The audio insight frame selector 302 is configured to receive a video stream 10. The audio insight frame selector 302 is configured to identify one or more anomalous events in an input video stream of traffic by applying spectral flux computation. The selector 302 is also configured to select each frame in the video stream that includes the identified one or more anomalous events. The frame selector may identify the frame based on audio data 20 and visual data 22 detected in each frame of the video stream 10.

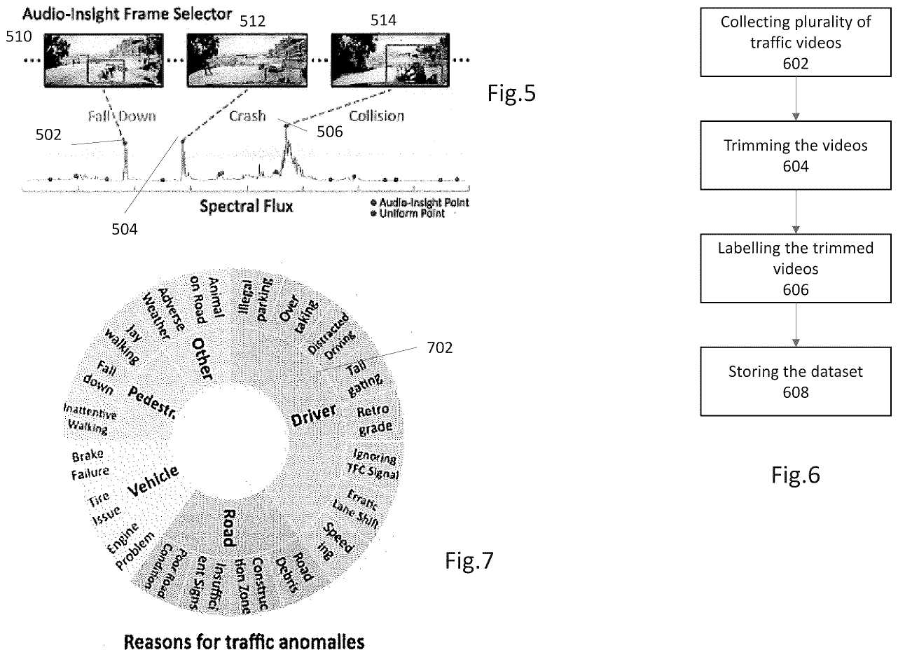

FIG. 5 illustrates an example of spectral flux computation performed by the audio insight frame selector 302. The audio insight frame selector 302 is configured to identify anomalous moments in the traffic video stream 10. Spectral flux measures changes in an audio signal's power spectrum by comparing consecutive frames, revealing sudden variations in the audio data. These audio shifts often align with key traffic events like braking, collisions, or alarms. By focusing on these audio-based cues, the selector 302 accurately selects relevant video frames, ensuring essential anomalies are captured. This alignment between audio and visual cues provides a more efficient and reliable approach to detecting traffic events, as shown in FIG. 5.

As shown in FIG. 5, the frames audio insight points 502, 504, 506 are identified. The audio insight points are points in the video stream 10 where the amplitude exceeds a threshold. The three frames 510, 512, 514 are selected due to the change in the power spectrum i.e., the large amplitude. As shown in FIG. 5, the spectral flux computation identifies frames 510, 512 and 514. The other points in the audio data are uniform points and ignored by the selector 302.

Referring to FIG. 5, spectral flux computation will be explained in more detail. Given a traffic anomaly video V, its audio time series A is extracted at a sampling rate of a kHz, where α is empirically set as 44.1 (e.g., a sampling rate of compact disc). The magnitude spectrogram of the audio signal is computed using the Short-Time Fourier Transform (STFT) with a Hamming window ω(m). Denoting Â(n, k) as the k-th frequency bin of the n-th point in the audio time series A, the STFT is computed as:

$$\hat{A} ( n , k ) = {\sum }_{m = - \frac{S}{2}}^{\frac{S}{2} - 1} A ( hn + m ) ω ( m ) {e}^{- \frac{2 jnmk}{S}} , \qquad ( 1 )$$

where the window size S is 2048 and the hop size h is 512.

Spectral flux (SF (n)) measures the change in magnitude for each frequency bin over time. By focusing on the positive changes and summing up the changes across all frequency bins, the spectral flux is computed as:

$$SF ( n ) = {\sum }_{m = - \frac{S}{2}}^{\frac{S}{2} - 1} H ( \vert \hat{A} ( n , k ) \vert - \vert \hat{A} ( n - 1 , k ) \vert ) , \qquad ( 2 )$$

where

$$H ( x ) = \frac{x \div \vert x \vert}{2}$$

is the half-wave rectifier function, ensuring that only positive changes contribute to the sum.

To capture key events throughout the audio duration, the Spectral Flux sequence is divided into T equal-length segments. In each segment, the point with the highest Spectral Flux value is located, marking the most significant spectral change, i.e.,

$${n}_{i}^{*} = {arg max}_{n ∈ [ {n}_{i}^{start} , {n}_{i}^{end} ]} SF ( n ) , \qquad ( 3 )$$

where i=1, 2, . . . , T and n; is a significant spectral change within segment i. These point n*ᵢ represent moments of potential importance in the traffic scenario, as they infer critical audio anomalies. For each n*ᵢ, the corresponding video frames are retrieved, identifying key frames in the original traffic anomaly video. The final set of selected frames is represented as

$$V = {\{ {V}^{t} \}}_{t = 1}^{T} ∈ {ℝ}^{T \times H \times W \times 3} ,$$

where H and W denote the height and width of each frame.

Referring to FIG. 4, the model comprises an audio encoder 304 and a visual encoder 306. The encoders are operatively coupled to the audio insight frame selector 302, as shown in FIG. 4. The encoders are adapted to receive the selected video frames and process the data from each modality separately.

The visual encoder 306 is configured to process the frames by applying a ViT-g/14 model to encode visual data. The selected key frames are fed into the visual encoder and the latent features are processed through a pre-trained image-level Q-former, yielding Nᵥ tokens per frame. This visual information is represented as

$${F}_{v} = {\{ {F}_{v}^{t} \}}_{t = 1}^{T} ∈ {ℝ}^{T \times {N}_{v} \times {d}_{v}}$$

where dᵥ denotes the visual feature dimension. Temporal structure is further enhanced by adding learnable position embeddings to the T dimension of Fᵥ.

The audio encoder 304 is configured to segment an audio time series extracted from the video frames into predefined segments, wherein each segment being a predefined time interval, transform the extracted audio time series at each segment into spectrograms, and generate encoded audio data. Additional detail of the audio encoder is provided below.

For the audio time series A extracted from the video, the mode is adapted to segment it into M parts, each spanning two seconds. These segments are converted into spectrograms with 128 mel-spectrogram bins. Treating spectrograms as 2D signals akin to images, they are encoded using a ViT. After encoding, the audio is represented as

$${F}_{a} = {\{ {F}_{a}^{m} \}}_{m = 1}^{M} ∈ {ℝ}^{M \times {N}_{a} \times {d}_{a}}$$

where Nₐ denotes the number of tokens per audio segment, and dₐ is the auditory feature dimension. Learnable position embeddings are added to the M dimensions of Fₐ to capture temporal information.

The temporal information may be used to capture the audio data and visual data that correspond to each other in the video stream 10. The selected audio data and visual data also are indicative of an anomaly i.e., a traffic incident.

The audio-visual dynamic connector 308 is configured to fuse the encoded visual data and the encoded audio data into a fused audio-visual data (fused AV data) by applying a self-attention mechanism.

The audio-visual dynamic connector 308 comprises three sub components. The module 308 (i.e., audio visual dynamic connector) comprises a visual Q former 320 (i.e., video Q former), an audio Q former 322, and a self-attention mechanism 324. The visual and audio Q-formers process visual tokens Fᵥ and audio tokens Fₐ to produce fixed-length token sets, i.e., Nᵥ for visual (i.e., video) and Nₐ for audio, as shown in FIG. 4. These tokens are projected into the LLM's embedding space. The video and audio tokens are then concatenated to form Fⱼ ∈ [symbol] (Nᵥ+Nₐ)×dᵢ wherein Fⱼ denotes the concatenated form of audio and visual tokens. Recognizing that the significance of different video/audio tokens may vary. The self-attention mechanism 324 (i.e., self-attention module) is designed to assign importance weights for each token. The dynamic connector 308 may comprise multiple self-attention layers followed by a linear layer 326, which takes Fⱼ as the input and generates weights W∈ [symbol] (Nᵥ+Nₐ)×1. The final input to the LLM 310 is computed as Fᵢₙₚᵤₜ=Fⱼ×W. This effectively prioritises tokens by learned importance. The self-attention mechanism 324 generate weights and apply the generated weights to the concatenated AV data set by dot product to generate an LLM input AV data set.

As shown in FIG. 4, the model 300 comprises a decoder 312. The decoder configured 312 may comprise a tokenizer adapted to convert the input Fᵢₙₚᵤₜ into language features. For example, the tokenizer of LLaMA2 may convert the input into language features represented as F₁ ∈ [symbol] Nᵢ×dᵢ, where Nᵢ is the number of tokens in the language instructions. These language features are then concatenated with the audio-visual input Fᵢₙₚᵤₜ to form the full input to the LLM for generating the final textual response.

In one example the LLM 310 is a LLaMA2 model, wherein the natural language outputs are a textual output. The textual outputs comprise at least one or more of: anomaly type, causal inference, prevention strategies and response recommendations.

According to a further aspect there is provided a computer-implemented method for generating a training dataset for a multi modal model 300. The dataset may be titled AV-TAU dataset. The AV-TAU dataset is a large-scale Audio-Visual dataset specifically designed to enhance traffic anomaly understanding (TAU). The AV-TAU dataset comprises at least 29,000 anomalous traffic videos and at least 149,000 targeted Q&A pairs. The Q&A pairs may be specifically directed toward five key traffic anomaly understanding tasks (i) identifying and describing anomalies through multimodal data, (ii) explaining the underlying causes, (iii) pinpointing the time windows of anomalies, (iv) recommending effective prevention strategies, and (v) providing suitable response solutions.

The dataset is generated by rigorous, multistage dataset construction process, employing 65 trained annotators to ensure thorough coverage, accurate annotation and validation at each stage.

FIG. 6 illustrates an example method 600 of generating a training dataset for use by the multi modal model (i.e., the machine learning model) 300. The method 600 comprises step 602. Step 602 comprises collecting a plurality of traffic videos from a plurality of sources, wherein each video depicts at least one traffic anomaly. Step 604 comprises trimming the videos to capture causes and consequences of the anomalies. Labelling the trimmed videos 606. The trimmed videos further include labels, the labels being textual outputs indicating information indicative of: anomaly type, causal inference, prevention strategies and response recommendations, wherein the textual outputs define Q&A pairs. Step 608 comprises storing the dataset.

The dataset generated provides a significant labelled dataset that can be used for future traffic anomaly detection development and for enhancing the multi modal model described herein.

Initially videos may be sourced from a plurality of online platforms such as for example YouTube, Twitter etc. using textual queries or prompts to obtain a broad spectrum of traffic anomalies. FIG. 7 illustrates a categorisation tool 702 of the various reasons for traffic anomalies. The reasons may be arranged in relation to various groups. Annotators then manually filtered this initial collection, retaining only videos that clearly depict traffic anomalies with relevant audio, leading to a focused and informative dataset.

Each video may be trimmed to capture the causes and consequences of anomalies, with annotators creating text-based answers for the five key tasks (described earlier) to form Q&A pairs. Also, a cross-validation process is conducted for consistency: each set of labels was independently reviewed by three annotators, with any discrepancies resolved by the authors.

The AV-TAU dataset provides 29,865 videos with 3.16 million frames, totaling 31.17 hours, with an average of 108.5 frames per video. The dataset spans five main anomaly categories, further divided into 20 subcategories as shown in FIG. 7. The dataset features diverse distributions in video lengths and anomaly time windows, offering a rich foundation for the development and training of the model 300.

The model 300 may be trained in two phases. A first phase includes multi modal alignment with InternVid-10M data. The dataset includes 10 million video and audio samples for producing video descriptions. The large dataset ensures alignment of the visual and auditory modalities with the language (i.e., natural language) modality. During this first phase, only the audio-visual dynamic connector is trained. The audio encoder may be initialized with pre trained weights e.g., from ImageBind. The model 300 may be trained for one epoch of the full Vid-10M dataset with a batch size of 128, using an AdamW optimizer. The learning rate may follow a cosine decay schedule with an initial warm up period, starting at 1e-4. In one example the training phase may be conducted on eight NVIDIA GTX A6000 GPUs, taking around 240 hours.

The second phase comprises instruction tuning for traffic anomaly understanding with the model 300. The second phase targets traffic anomaly detection using the multi modal model 300 using a training dataset. The inputs include video, audio, and a related question, whereas the output is an answer aimed at understanding and responding to traffic anomaly. Both the audio-visual dynamic connector and the LoRA 2 based LLM are trained, keeping the visual and audio encoders frozen. This instruction tuning phase improves the model's accuracy in identifying and interpreting anomalies. In this phase, the model is trained for one epoch on the AV-TAU dataset with a batch size of 16, using the AdamW optimizer with a cosine learning rate decay and a warm-up period, starting at a learning rate of 2e-5. The LoRA parameters were set to r=64 and a: =128. Training in this phase may be conducted on eight NVIDIA GTX A6000 GPUs, taking approximately three hours. Alternatively, the training may be performed by the computing apparatus 200. The computing apparatus may comprise multiple GPUs e.g., eight NVIDIA GTX A6000 GPUs.

Experiments were conducted by the inventors on the AV-TAU dataset with a 90%-10% train-test split. The test set may include 3000 videos and 15,000 Q&A pairs providing robust basis for evaluating the performance of the model 300 compared to other models. Quantitative comparison and qualitative comparison were performed between the multi modal model 300 and other commonly used traffic anomaly detection models.

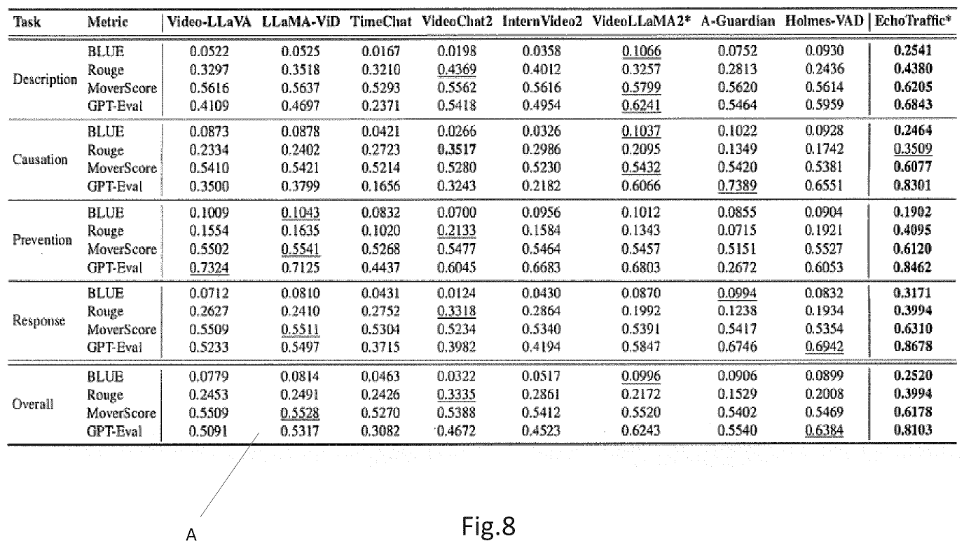

The model 300 was termed Echo Traffic. References to Echo Traffic refer to the model 300. Table A in FIG. 8 highlights EchoTraffic's superior performance across all evaluation metrics, underscoring its advanced capabilities in traffic anomaly understanding. Key findings include: (i) EchoTraffic consistently achieves the highest scores in text-level BLEU, ROUGE, MoverScore, and GPT-Eval metrics across all categories, indicating superior performance of the model 300 in the Description, Causation, Prevention, and Response subtasks; (ii) VideoLLaMA2 and Holmes-VADshow competitive performance, with VideoLLaMA2 benefiting from integrated audio signals and Holmes-VAD leveraging extensive training on anomaly videos.

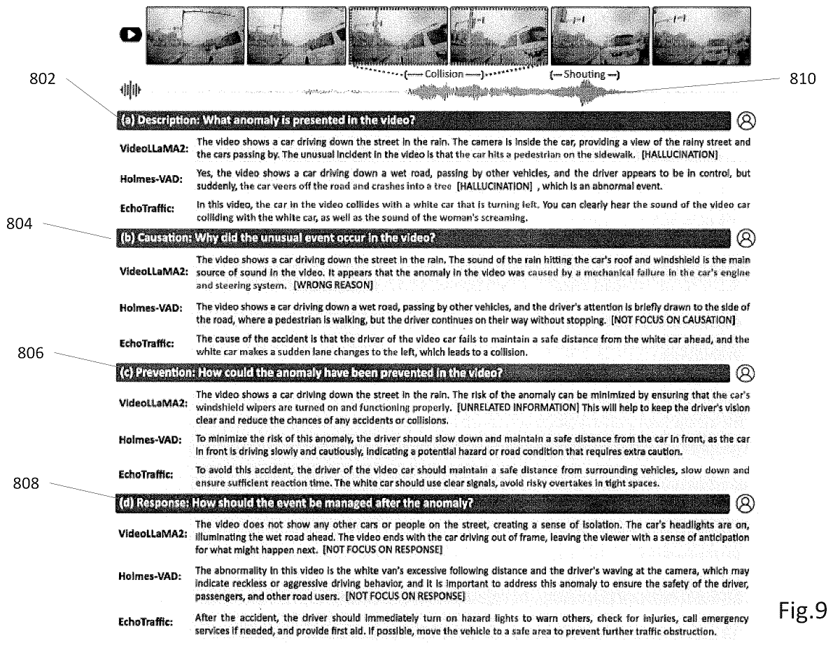

To provide qualitative insights into EchoTraffic's capabilities, the model performance is compared with VideoLLaMA2 and Holmes-VAD. FIG. 9 illustrates a challenging scenario where limited visual cues make detecting a collision difficult, as it occurs in a blind spot without causing camera shake. Nonetheless, Echo Traffic (model 300) excels at accurately detecting, interpreting, and focusing on traffic anomalies. The audio data 810 is detected and the frames where an audio anomaly is detected is selected. For instance, at test 802 (a) VideoLLaMA2 and Holmes-YAO fail to identify anomalies from visual cues, resulting in hallucinations, while EchoTraffic accurately infers a collision between the ego vehicle and a white car ahead using audio cues. At 804 and 808, VideoLLaMA2 and Holmes-VAD do not provide the correct response recommendation or an accurate causal interpretation after the incident. At 806, Holmes-VAD partially suggests a prevention strategy, while VideoLLaMA2 focuses on irrelevant information.

These observations underscore EchoTraffic's effectiveness and capability in leveraging audio-visual insights to accurately perceive and analyse complex traffic anomalies. Evaluation results demonstrate the model's 300 (i.e., EchoTraffic's) effectiveness in accurately understanding and reasoning about complex incidents, contributing to safer and more responsive urban transport systems.

The system and method enhance traffic anomaly understanding by integrating audio and visual data, overcoming the limitations of visual-only methods. By incorporating audio cues such as honking, collisions, and braking sounds, a more comprehensive understanding is provided, even for events outside the camera's field of view or in poor visibility conditions. The use of audio and visual cues provides a more accurate and timely detection of traffic anomalies (i.e., traffic incidents). Cost-effective and versatile, the invention supports applications in traffic management, autonomous vehicles, emergency response, and insurance. Its ability to deliver user-friendly outputs ensures accessibility for both technical and non-technical users, establishing it as a significant improvement over existing methods and approaches.

By integrating both audio and visual data, the system and model 300 enables advanced detection and analysis of traffic anomalies, such as accidents, near-misses, or unusual behaviors. Beyond detection, the system 100 identifies underlying causes of anomalies, generates preventive strategies, and provides real-time actionable responses. Traditional traffic monitoring systems, which rely primarily on visual data, often fail to capture crucial audio cues like honking, braking, or collisions. The system 100, method 400 and model 300 address these limitations, bridging the gap between anomaly detection and delivering actionable insights, making it an essential tool for improving public safety and transportation efficiency.

In smart traffic management, the system 100 enables real-time detection and resolution of traffic disruptions, ensuring smoother traffic flow. It enhances autonomous vehicle technologies by detecting out-of-view anomalies, such as distant collisions or honking sounds, allowing vehicles to proactively respond to potential hazards. For emergency services, the system 100, method 400 and model 300 can facilitate faster and more effective incident response by providing detailed event descriptions and recommendations. Insights i.e., outputs from the system 100 can also guide urban planners and policymakers in designing safer road systems by identifying recurring causes of traffic anomalies. In addition to improving road safety, the system 100, model 300 and method 400 can benefit the insurance and legal sectors by providing comprehensive reports on traffic incidents, including causation and response details, which aid in determining liability. The system 100 and model 300 can support driver education and training by offering real-world examples of traffic scenarios and preventive strategies. For traffic surveillance systems, the system 100 upgrades their functionality by integrating audio-visual capabilities, enabling the detection of off-camera or out-of-view incidents. Furthermore, the system 100 serves as a benchmark for research and development in multimodal AI, driving innovation in traffic safety technologies.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, or a removable disk, or any other form of storage medium known in the art. A storage medium may be coupled to the processor such that the processor can read information from, and write information to, the storage medium. In the alternative, the storage medium may be integral to the processor.

One or more of the components and functions illustrated the figures may be rearranged and/or combined into a single component or embodied in several components without departing from the scope of the invention. Additional elements or components may also be added without departing from the scope of the invention. Additionally, the features described herein may be implemented in software, hardware, as a business method, and/or combination thereof.

1. A computer-implemented method for identifying a traffic anomaly, comprising:
receiving a video stream of traffic, wherein the video stream comprises two input categories
wherein the two input categories are audio data and visual data,
simultaneously processing audio data and visual data to identify a traffic anomaly,
generating an output of the identified traffic anomaly, and;
presenting the generated output of the identified traffic anomaly to a user.

2. The method of claim 1, wherein the output is a textual description of the identified traffic anomaly or traffic anomalies.

3. The method of claim 2, comprising the step of identifying one or more anomalous events in the video stream by applying spectral flux computation.

4. The method of claim 3, wherein spectral flux computation comprises:
measuring a change in audio data power spectrum by comparing consecutive frames in the video stream,
determining sudden variations in the audio data,
wherein the sudden variations in the audio data are indicative of a traffic anomaly,
selecting frames within which the sudden variations in the audio data are determined.

5. The method of claim 4, wherein the step of selecting frames comprises detecting a highest spectral value or largest amplitude at each predefined time segment of the video stream and selecting frames where the highest spectral value or largest amplitude is detected.

6. The method of claim 4, comprising:
feeding the audio data into an audio encoder,
transforming audio data into spectrograms,
generating encoded audio data, wherein the encoded audio data comprises a plurality of audio tokens.

7. The method of claim 6, comprising:
feeding the selected frames into a visual encoder,
processing the selected frames to extract visual features,
generating encoded visual data, wherein the encoded visual data comprises a plurality of visual tokens.

8. The method of claim 7, comprising merging the encoded visual data and encoded audio data into a fused audio-visual data (AV data) by applying self-attention mechanisms to balance contributions of audio data and visual data in the fused AV data.

9. The method of claim 8, wherein the step of merging the encoded visual data and encoded audio data into the fused AV data comprising the additional steps of:
producing a fixed length audio token set by processing the audio tokens by an audio Q former,
producing a fixed length visual token set by processing the visual tokens by a video Q former,
projecting the into a large language model embedding space,
wherein the audio tokens and visual tokens are concatenated into the fused AV data.

10. The method of claim 8, comprising the steps of:
decoding the fused AV data,
generating natural language outputs from the decoded fused AV data.

11. The method of claim 10, wherein the natural language outputs are textual outputs, and the method comprises presenting the textual outputs on a display.

12. The method of claim 10, wherein the natural language outputs comprise at least one or more of: identified anomaly type, causal inference, prevention strategies and response recommendations.

13. The method of claim 10, wherein the decoding and generating natural language outputs are generated by a LLaMA2 large language model that is trained to process the fused AV data and generate the natural language outputs.

14. A multi modal model for identifying a traffic anomaly, in particular for use in the method of claim 1, comprising:
an audio insight frame selector configured to identify one or more anomalous events in an input video stream of traffic by applying spectral flux computation, and select each frame in the video stream that includes the identified one or more anomalous events,
an audio encoder and a visual encoder operatively coupled to the audio insight frame selector, the audio encoder and visual encoders adapted to receive the selected video frames,
wherein the visual encoder is configured to:
process the frames by applying a ViT-g/14 model to encode visual data,
wherein the audio encoder is configured to:
segment an audio time series extracted from the video frames into predefined segments, wherein each segment being a predefined time interval,
transform the extracted audio time series at each segment into spectrograms,
generate encoded audio data,
an audio-visual dynamic connector configured to fuse the encoded visual data and the encoded audio data into a fused audio-visual data (fused AV data) by applying a self-attention mechanism,
wherein the audio-visual dynamic connector comprising:
a visual Q former,
an audio Q former,
a self-attention mechanism,
the visual Q former and the audio Q former are configured to process the encoded visual data and encoded audio data respectively to produce one or more fixed length token sets,
the audio-visual dynamic connector configured to concatenate the fixed length token sets and generate a concatenated AV data set,
the self-attention mechanism generates weights and apply the generated weights to the concatenated AV data set by dot product to generate an LLM input AV data set,
a decoder configured to:
receive LLM input AV data set,
convert the input AV data set into language features, and;
concatenate the language features to form one or more prompts,
a large language model (LLM) that is trained to process the concatenated language features and generate one or more natural language outputs, wherein the LLM is a LLaMA2 model, wherein the natural language outputs are a textual output and;
wherein the textual outputs comprise at least one or more of: anomaly type, causal inference, prevention strategies and response recommendations.

15. A system for identifying a traffic anomaly comprising:
a computing apparatus comprising a processor and a memory unit, the processor and memory unit being operatively coupled to each other,
the computing apparatus further comprising a display operatively coupled to the processor, the display adapted to present one or more outputs,
the computing apparatus further comprising:
an audio insight frame selector configured to identify one or more anomalous events in an input video stream of traffic by applying spectral flux computation, and select each frame in the video stream that includes the identified one or more anomalous events,
an audio encoder and a visual encoder, the encoders configured to generate encoded audio data and encoded visual data,
an audio-visual dynamic connector configured to fuse the encoded visual data and the encoded audio data into a fused audio-visual data (fused AV data),
a large language model (LLM) that is trained to process the fused AV data and generate one or more natural language outputs,
wherein the natural language outputs are presented on the display.

16. The system of claim 15, wherein the natural language outputs are a textual output and; wherein the textual outputs comprise at least one or more of: anomaly type, causal inference, prevention strategies and response recommendations, and display configured to present the textual outputs to a user.

17. The system of claim 16, wherein the visual encoder is configured to: process the frames by applying a ViT-g/14 model to generate encoded visual data,
wherein the audio encoder is configured to: segment an audio time series extracted from the video frames into predefined segments, wherein each segment being a predefined time interval, transform the extracted audio time series at each segment into spectrograms, and generate encoded audio data.

18. The system of claim 15 wherein the audio-visual dynamic connector comprising:
a visual Q former,
an audio Q former,
a self-attention mechanism,
wherein the visual Q former and the audio Q former are configured to process the encoded visual data and encoded audio data respectively to produce one or more fixed length token sets,
wherein the audio-visual dynamic connector configured to concatenate the fixed length token sets and generate a concatenated AV data set,
wherein the self-attention mechanism generates weights and apply the generated weights to the concatenated AV data set by dot product to generate an LLM input AV data set,
the computing apparatus further comprising
a decoder configured to:
receive LLM input AV data set,
convert the input AV data set into language features, and;
concatenate the language features to form one or more prompts,
wherein the large language model (LLM) is configured to process the concatenated language features and generate the one or more natural language outputs, and wherein the LLM is a LLaMA2 model.
